(19) United States
(12) Patent Application Publication
(10) Pub. No.: US 2018/0285876 A1
(43) Pub. Date: Oct. 4, 2018

(54) DOMAIN-SPECIFIC CONFIGURABLE FRAUD PREVENTION

(71) Applicant: NCR Corporation, Duluth, GA (US)

(72) Inventors: Boris Vrtic, London (GB); James Alexander Grove Annesley, Surrey (GB); Geoffrey Scott Butler, London (GB); Edward William Spencer, Buckinghamshire (GB)

(21) Appl. No.: 15/474,246

(22) Filed: Mar. 30, 2017

(51) Int. Cl. G06Q 20/40; G06N 5/02; G06N 99/00

(52) U.S. Cl. CPC G06Q 20/4016; G06F 3/0482; G06N 99/005; G06N 5/025

(57) ABSTRACT

Various embodiments herein each include at least one of systems, methods, and software that provide domain-specific configurable fraud prevention solutions. One such embodiment, in the form of a method, includes presenting a user interface including a plurality of controls tailored to present and receive input defining fraud detection rules. Input may then be received within the user interface defining a fraud detection rule where the input identifies at least one transaction-related data item and a data condition. This method then stores the received input as a fraud detection rule in a rule base.

### BACKGROUND INFORMATION

Fraud in financial transactions has become common. With payment and bank withdrawal transactions being processed electronically, previous forms of fraud detection, such as were possible when transactions were conducted between a teller and a customer, are no longer possible. To address fraud in processing transactions electronically, financial institutions have developed systems that apply simple fraud detection rules. However, these systems are generally monolithic and any change, such as a new fraud-type that exploits a newly discovered bug or security hole, requires a computer programmer to code up a new version of the fraud detection process and deploy it. While this may be effective, it is time consuming and expensive. Often, but the time the new version is developed, tested, and deployed, the new fraud-type has already been committed and may not be seen again. The new version is therefore too late to be helpful. Further, statutory, regulatory, and industry standards impose restrictions on who and what processes can access and manipulate certain data and newly deployed code can present new and additional bugs and security holes that may be exploited through transaction fraud and hacking. Thus, while current solutions have been effective in some regards, these solutions have many shortcomings and create addition risk.

### SUMMARY

Various embodiments herein each include at least one of systems, methods, and software that provide domain-specific configurable fraud prevention solutions.

One such embodiment, in the form of a method, includes presenting a user interface including a plurality of controls tailored to present and receive input defining fraud detection rules. Input may then be received within the user interface defining a fraud detection rule where the input identifies at least one transaction-related related data item and a data condition. This method then stores the received input as a fraud detection rule in a rule base.

Some embodiments of this method further include receiving, from a requestor, transaction data of an open transaction subject to approval. These embodiments may then retrieve at least the fraud detection rule from the rule base based on at least one data item included in the transaction data. The at least one rule, in some such embodiments, is formatted according to a fraud detection language. These embodiments then apply at least the retrieved fraud detection rule to the received transaction data to obtain a result.

Some additional embodiments of this method may then reply to the requestor with a fraud detection transaction approval, an alert, or a transaction denial. A fraud detection transaction approval is typically subject to other possible transaction approvals and is provided when there is a low or no fraud possibility detected as included in the result from the applying of at least one retrieved fraud detection rule. An alert may be provided when there is a fraud possibility greater than a first threshold detected as included in the result from the applying of at least one retrieved fraud detection rule. A transaction denial may be provided when there is a fraud possibility greater than a second threshold detected as included in the result from the applying of at least one retrieved fraud detection rule.

Another embodiment is in the form of a system. The system of such embodiments includes a network interface device, at least one processor, and a memory device storing instructions executable by the at least one processor to perform data processing activities. The data processing activities may include transmitting, via the network interface device to a client device, data for presenting in a user interface including a plurality of controls tailored to present and receive input defining fraud detection rules. The data processing activities may also include receiving, via the network interface device from the client device, data received as input within the user interface on the client device, the data defining a fraud detection rule identifying at least one transaction-related data item and a data condition. The data processing activates may then store the received data as a fraud detection rule in a rule base.

### BRIEF DESCRIPTION OF ME DRAWINGS

FIG. 1 is a logical block diagram of a system, according to an example embodiment.

FIG. 2 is a fraud detection rule creation and updating user interface, according to an example embodiment.

FIG. 3 is a logical block flow diagram of a method, according to an example embodiment.

FIG. 4 is a logical block flow diagram of a method, according to an example embodiment.

FIG. 5 is a block diagram of a computing device, according to an example embodiment.

### DETAILED DESCRIPTION

Some of the various embodiments herein provide smart, self-learning fraud detection and prevention solutions. Some embodiments combine self-learning analytical models with user-defined rules and profiles to achieve exceptionally high fraud detection rates with low false positive ratios. Flexible, scalable, and easily configurable, there are embodiments suitable for organizations of any size.

The various embodiments provide enterprise-level fraud detection that can be deployed to protect all channels, all accounts, and all payment types from a single platform. For example, a retail bank can monitor all card transactions and digital banking events. Further, an acquirer, payment service provider (PSP), merchant, or processor, can monitor one or both of traditional brick-and-mortar transactions and e-commerce transactions taking payments from cards to e-wallets to bank payments. Typical embodiments allow for assessment of individual transactions as well as historical and aggregated behavior across multiple accounts or groups of accounts.

Further, some embodiments provide enriched fraud screening capabilities by incorporating data from the widest possible range of sources. In addition to the usual transactional information, such embodiments can be augmented to include data from other internal or external systems and fraud-scoring models. These and other embodiments also may leverage information provided by specialist third parties, allowing incorporation of extra data about devices, IP addresses, and geo-locations of payment sources, for instance.

When deployed with a suitable payments processing engine, some embodiments enable real-time, in-flight fraud blocking. Some embodiments may also allow near real-time and batch detection modes even where source systems do not support real-time.

Such embodiments may also include an analytics engine that may use one or a mixture of Bayesian modelling and other modern techniques instead of the more common, outdated neural network technology. This enables fraud identification much more accurately using sparse data sets and an ability to learn and adapt as fraud patterns emerge and change allowing delivery of a highly accurate level of fraud detection with low false positives thereby minimizing blocking of genuine transactions and improving customer satisfaction.

Some such embodiments enable implementers to have total strategic control of their system by enabling a user to configure and manage most details of their deployment, such as fraud detection rule definitions, third-party data sources, compound and complex rules, and the like. At the same time, some embodiments may be deployed in a hosted manner in the cloud partially or wholly administered by a service provider.

These and other embodiments are described herein with reference to the figures.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, application specific integrated circuit (ASIC), field programmable gate array (FPGA), microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

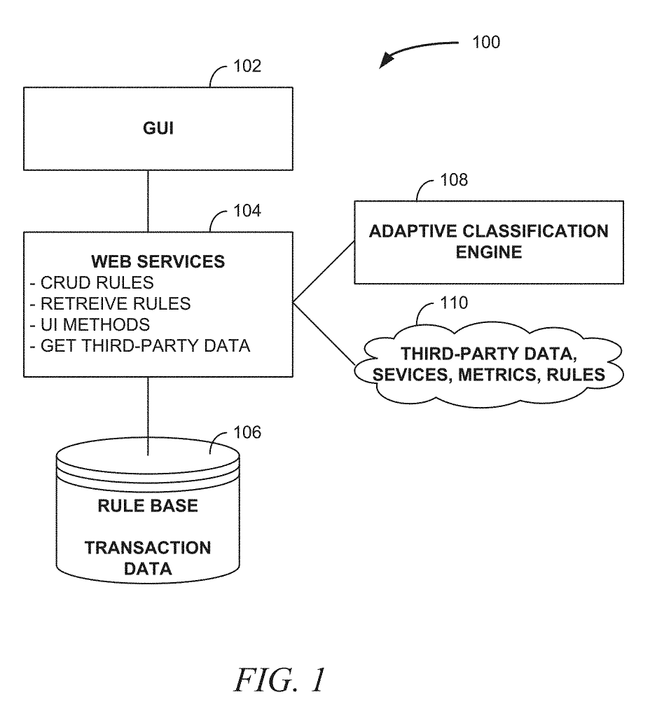

FIG. 1 is a logical block diagram of a system 100, according to an example embodiment. The system 100 operates to provide a set of graphical user interfaces (GUI) 102 that allow users to access web services 104 to define financial transaction fraud detection rules. The fraud detection rules are stored in a rule base that may be stored in a database 106. The rule base may include a collection of fraud detection rules. Financial transaction data may also be stored in the database 106. In some embodiments, the database 106 may be one or more databases located in an on premises data center where some or all of the other components of the system 100 are deployed. However, in some embodiments, some or all of the components of the system 100 may be deployed in the cloud.

The GUIs 102 may be user interfaces that are provided by the web services 104 in response to user requests received over a network, such as the Internet, an intranet, and the like. User interface requests may be received from a web browser, a mobile device app, a thin or thick client application, and the like. The GUI provided may be an entirety of a user interface in a markup language renderable by a web browser or an app or an application from which the request was received. In some embodiments, the GUI provided is data that invokes certain user interface elements, controls, and the like that may be present in a mobile device app or a thin or thick client application already present on the requesting client device.

The GUIs 102 may be utilized to create, read, update, and delete financial transaction fraud detection rules. Thus, when a GUI 102 is provided to a client, if the request for the GUI 102 is with regard to an existing rule, the web services 104 may retrieve the existing rule from the rule base in the database 106 to include in the GUI 102 data sent to the requesting client. Further, the web services 104 include rules to create, update, and delete rules within the rule base, as well as user interface methods to implement commands received from the GUIs 102.

A financial transaction fraud detection rule may identify one or more financial transaction related data items that may be included with or retrievable based upon data included in a financial transaction dataset. A financial transaction dataset may be received from a merchant, a bankcard (e.g., debit, ATM, credit, prepaid, or charge card). The financial transaction data may be processed in real time in some embodiments before the transaction is allowed to be completed. In some embodiments, financial transaction data may be processed, individually or in a batch, after the transaction has been completed. Other embodiments may include fraud detection processing in part while the transaction is pending and different processing after being completed.

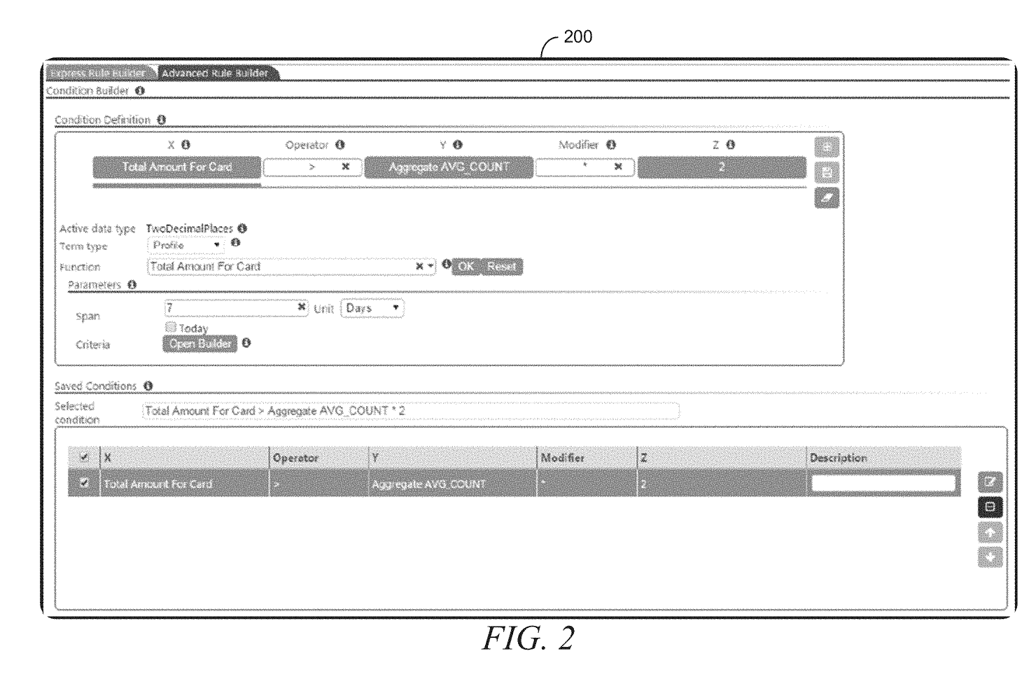

The fraud detection rules created with the GUIs 102 and stored in the rule base of the database 106 may identify one or more financial transaction data items and possible values that might be indicative of fraud. Some rules are defined within a GUI 102 in an XYZ format such that at least one transaction-related data item is the X and the data condition includes the Y and Z. The X and Y are typically separated by an operator (e.g., =, >, <, NOT, etc.) and the Y and Z are separated by a modifier (e.g., multiply, divide, subtract, add, absolute value, etc.) where the rule is X compared to Y as modified by Z. An example of a GUI 102 with regard to such an XYZ rule is illustrated in FIG. 2.

Rules may also be defined with other logical operation schemas, such as CHOOSE-CASE statements, IF-THEN-ELSE, and the like.

Some financial transaction fraud detection rules may depend upon one or more of third-party resources 110, such as data, services, metrics, and rules. Such third-party resources 110 may be available in a GUI 102, such as the GUI 200 in FIG. 2, through a drop-down list box or other user interface control. In other embodiments, the third-party resources 110 can be input manually.

Once defined and stored in the database 106, the financial transaction fraud detection rule is available for application against financial transaction data by an adaptive classification engine (ACE) 108. The ACE 108 interprets the rules to apply the rules against the financial transaction data, which may include retrieval, calculation, and other operations against data stored in the database 106 and as may be retrieved from the third-party resources 110. A financial transaction may be blocked, allowed, an alert generated and transmitted with regard thereto, flagged for further review, and the like. The actions taken based on a result of application of a rule to financial transaction data may be defined within a rule or be a default such that when rule application results in a positive result, fraud is detected and invokes a handler process therefor. However, some rules may contribute to a scoring algorithm of the ACE 108 in some embodiments. The ACE 108 may consider results of a plurality of rules in reaching a conclusion as to the presence or likelihood of fraud in a financial transaction. Some rules may be weighted greater than others and the weighting may be dynamic based on learned outcomes and administrator input and corrections with regard to historic rule outputs, ACE 108 classification. Thus, ACE 108 results may also be stored in the database 106 and a GUI 102 may be included in some embodiments that allows an administrative user to review and modify results, which then provides feedback to the ACE 108 for future classifications. Administrative users may also modify weightings learned or otherwise configured with regard to rules by the ACE 108.

FIG. 2 is a fraud detection rule creation and updating user interface 200, according to an example embodiment. The user interface 200 has been generally described above. However, in some embodiments, underlying the user interface 200 controls is a fraud detection rule language. A fraud detection rule language is used in some embodiments, as opposed to another common, well known, and open language (e.g., Java, Java. Script, C/C++, etc.), to limit at least one of data items and operations that may be included in fraud detection rules. This provides a greater level of security in some embodiments as other known or discovered security issues and copied code do not make their way into the solution. Further, as the language is not known, those with nefarious intentions will have a more difficult time discovering and exploiting vulnerabilities. Direct user interaction is also prevented at least in part thereby. In some embodiments, the fraud detection language is generated according to a fraud detection grammar processed by a parser generator, such as ANTLR.

The user interface 200, as well as the other GUIs 102 of FIG. 1, enable users to define and maintain fraud detection rules according to their own organizational needs. This removes the requirement for a new fraud detection system version or new module or modification of an existing module to accommodate fraud detection processing in view of a newly discovered exploit. This enables organizations to react more quickly and inexpensively.

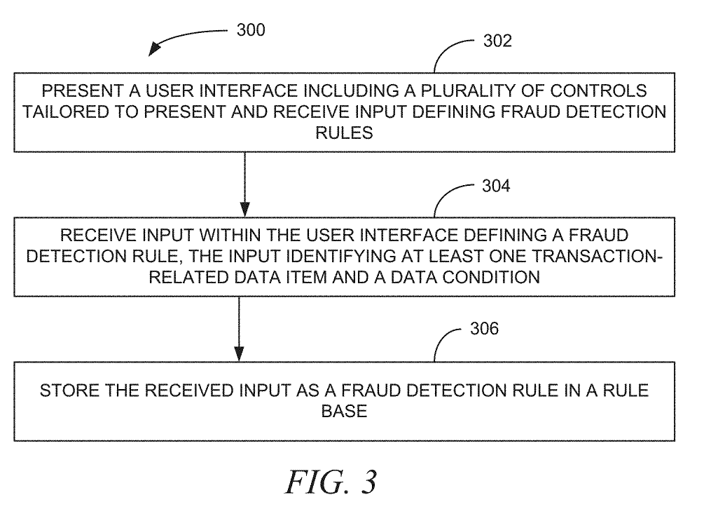

FIG. 3 is a logical block flow diagram of a method 300, according to an example embodiment. The method 300 is an example of method through which fraud detection rules may be defined. The method 300 includes presenting 302 a user interface including a plurality of controls tailored to present and receive input defining fraud detection rules. Presenting 302 the user interface, in some embodiments, includes transmitting data of a user interface over a network to a requesting client app, application, or web browser that executes on a client device. The method 300 also includes receiving 304 input within the user interface defining a fraud detection rule, the input identifying at least one transaction-related data item and a condition of one or more data items. Receiving 304 the input, in some embodiments, includes receiving data over a network from a client app, application, or web browser that executes on a client device. The method 300 may then store 306 the received input as a fraud detection rule in a rule base.

In some embodiments, the at least one transaction-related data item and the data condition included with the received 304 date are with regard to historic transaction data representative of previous transactions with regard to an account holder in relation to at least one of a merchant and a location.

In some embodiments, the fraud detection rule is stored 306 in the rule base in a format according to a fraud detection language. The fraud detection language in such embodiments, limits at least one of data items and operations that may be included in fraud detection rules.

In some embodiments, when the stored 306 fraud detection rule is applied to data of a transaction and when the fraud detection rule is satisfied, a potential fraud condition is identified. When the potential fraud condition is identified, some embodiments include at least one of flagging the transaction in stored data as having fraud potential, generating and providing at least one potential fraud alert, and blocking the transaction.

In some embodiments of the method 300, the received 304 input identifies a third-party data item to be retrieved over a network from the third-party and considered when the fraud detection rule is applied. In some further embodiments, the received 304 input identifies at least one additional fraud detection rule that is to be conditionally applied based on a result of the fraud detection rule.

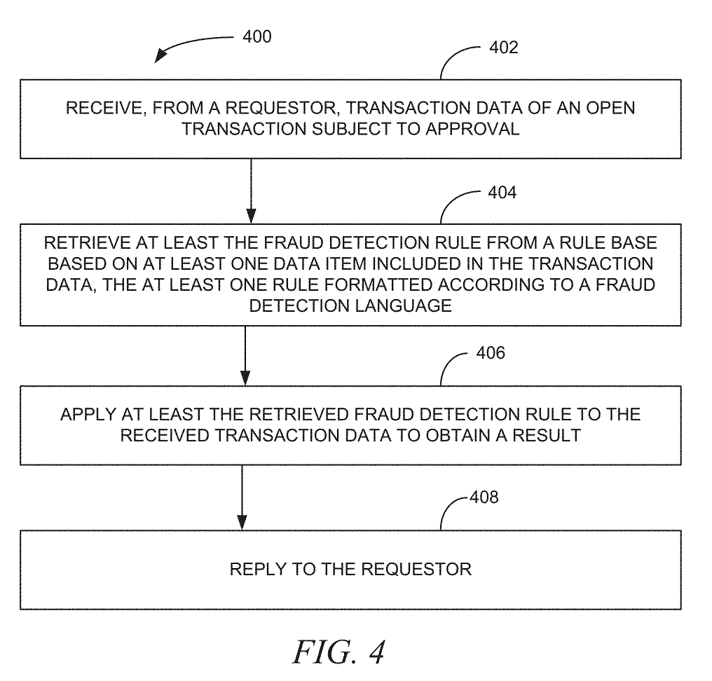

FIG. 4 is a logical block flow diagram of a method 400, according to an example embodiment. The method 400 is a continuation of the method 300 of FIG. 3. In some embodiments, the method 400 includes receiving 402 from a requester, transaction data of an open transaction subject to approval and retrieving 404 at least the fraud detection rule (of the method 300) from the rule base based on at least one data item included in the transaction data. The method 400 may then apply 406 at least the retrieved fraud detection rule to the received transaction data to obtain a result and reply 408 to the requester.

In some embodiments, the reply 408 may include one or more of an approval, an alert, and a denial. A fraud detection approval may include an approval, subject to other possible transaction approvals, when there is a low or no fraud possibility detected as included in the result from the applying 406 of at least one retrieved fraud detection rule. An alert, in some embodiments, is when there is a fraud possibility greater than a first threshold detected as included in the result from the applying 406 of at least one retrieved fraud detection rule. A transaction denial in some embodiments is when there is a fraud possibility greater than a second threshold detected as included in the result from the applying 406 of at least one retrieved fraud detection rule. Note that the first and second thresholds may be configurable, hardcoded, be set as part of a rule, and the like.

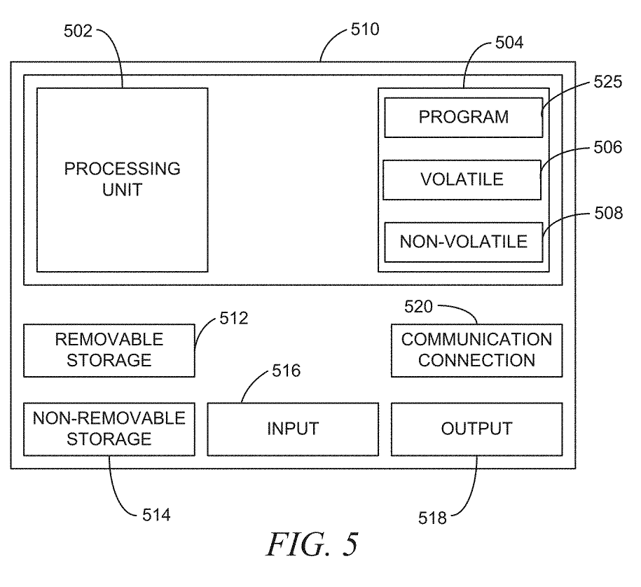

FIG. 5 is a block diagram of a computing device, according to an example embodiment. In one embodiment, multiple such computer systems are utilized in a distributed network to implement multiple components in a transaction-based environment, such as in the system illustrated in FIG. 1. An object-oriented, service-oriented, or other architecture may be used to implement such functions and communicate between the multiple systems and components. One example computing device in the form of a computer 510, may include a processing unit 502, memory 504, removable storage 512, and non-removable storage 514. Although the example computing device is illustrated and described as computer 510, the computing device may he in different forms in different embodiments. For example, the computing device may instead be a smartphone, a tablet, smartwatch, or other computing device including the same or similar elements as illustrated and described with regard to FIG. 5. Devices such as smartphones, tablets, and smartwatches are generally collectively referred to as mobile devices. Further, although the various data storage elements are illustrated as part of the computer 510, the storage may also or alternatively include cloud-based storage accessible via a network, such as the Internet.

Returning to the computer 510, memory 504 may include volatile memory 506 and non-volatile memory 508. Computer 510 may include—or have access to a computing environment that includes a variety of computer-readable media, such as volatile memory 506 and non-volatile memory 508, removable storage 512 and non-removable storage 514. Computer storage includes random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 510 may include or have access to a computing environment that includes input 516, output 518, and a communication connection 520. The input 516 may include one or more of a touchscreen, touchpad, mouse, keyboard, camera, one or more device-specific buttons, one or more sensors integrated within or coupled via wired or wireless data connections to the computer 510, and other input devices. The computer 510 may operate in a networked environment using a communication connection 520 to connect to one or more remote computers, such as database servers, web servers, and other computing device. An example remote computer may include a personal computer (PC), server, router, network PC, a peer device or other common network node, or the like. The communication connection 520 may be a network interface device such as one or both of an Ethernet card and a wireless card or circuit that may be connected to a network. The network may include one or more of a Local Area Network (LAN), a Wide Area. Network (WAN), the Internet, and other networks. In some embodiments, the communication connection 520 may also or alternatively include a transceiver device, such as a BLUETOOTH® device that enables the computer 510 to wirelessly receive, data from and transmit data to other BLUETOOTH® devices.

Computer-readable instructions stored on a computer-readable medium are executable by the processing unit 502 of the computer 510. A hard. drive (magnetic disk or solid state), CD-ROM, and RAM are some examples of articles including a non-transitory computer-readable medium. For example, various computer programs 525 or apps, such as one or more applications and. modules implementing one or more of the methods illustrated and described herein or an app or application that executes on a mobile device or is accessible via a web browser, may be stored on a non-transitory computer-readable medium.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A method comprising:
presenting a user interface including a plurality of controls tailored to present and receive input defining fraud detection rules;
receiving input within the user interface defining a fraud detection rule, the input identifying at least one transaction-related data item and a data condition; and
storing the received input as a fraud detection rule in a rule base that includes a plurality of fraud detection rules.

2. The method of claim 1, wherein the fraud detection rule is stored in the rule base in a format according to a fraud detection language.

3. The method of claim 2, wherein the fraud detection language limits at least one of data items and operations that may be included in fraud detection rules.

4. The method of claim 2, wherein the fraud detection language is generated according to a fraud detection grammar processed by a parser generator.

5. The method of claim 4, wherein the parser generator is ANTLR.

6. The method of claim 1, wherein the received input defines the fraud detection rule in an XYZ format, wherein the at least one transaction-related data item is the X the data condition includes the Y and Z, wherein the X and Y are separated by an operator and the Y and Z are separated by a modifier where the rule is X compared to Y as modified by Z.

7. The method of 1, wherein when the fraud detection rule is applied to data of a transaction and when the fraud detection rule is satisfied, a potential fraud condition is identified.

8. The method of claim 7, wherein when the potential fraud condition is identified with regard to the transaction, performing at least one of flagging the transaction in stored data having fraud potential, generating and providing at least one potential fraud alert, and blocking the transaction from being completed.

9. The method of claim 1, wherein the received input identifies a third-party data item to be retrieved over a network from the third-party and considered when the fraud detection rule is applied.

10. The method of claim 1, wherein the received input identifies at least one additional fraud detection rule that is to be conditionally applied based on a result of the fraud detection rule.

11. The method of claim 1, further comprising:
receiving, from a requestor, transaction data of an open transaction subject to approval;
retrieving at least the fraud detection rule from the rule base based on at least one data item included in the transaction data, the at least one rule formatted according to a fraud detection language;
applying at least the retrieved fraud detection rule to the received transaction data to obtain a result.

12. The method of claim 11, further comprising:
replying to the requester with:
a fraud detection approval, subject to other possible transaction approvals, when there is a low or no fraud possibility detected as included in the result from the applying of at least one retrieved fraud detection rule;
an alert when there is a fraud possibility greater than a first threshold detected as included in the result from the applying of at least one retrieved fraud detection rule; and
a transaction denial when there is a fraud possibility greater than a second threshold detected as included in the result from the applying of at least one retrieved fraud detection rule.

13. The method of claim 1, wherein the at least one transaction-related data item and the data condition are with regard to historic transaction data representative of previous transactions with regard to an account holder in relation to at least one of a merchant and a location.

14. A system comprising:
a network interface device;
at least one processor; and
a memory device storing instructions executable by the at least one processor to perform data processing activities comprising:
transmitting, via the network interface device to a client device, data for presenting in a user interface including a plurality of controls tailored to present and receive input defining fraud detection rules;
receiving, via the network interface from the client device, data received as input within the user interface on the client device, the data defining a fraud detection rule identifying at least one transaction-related data item and a data condition; and
storing the received data as a fraud detection rule in a rule base.

15. The system of claim 14, wherein storing the received data as a fraud detection rule in the rule base includes transmitting the data via the network interface device to a network accessible database for storage.

16. The system of claim 14, wherein the received data defines fraud detection rule in an XYZ format, wherein the at least one transaction-related data item is the X the data condition includes the Y and Z, wherein the X and Y are separated by an operator and the Y and Z are separated by a modifier where the rule is X compared to Y as modified by Z.

17. The system of claim 14, the data processing activities further comprising:
receiving, via the network interface device from a requestor, transaction data of an open transaction subject to approval;
retrieving at least the fraud detection rule from the rule base based on at least one data item included in the transaction data, the at least one rule formatted according to a fraud detection language;
applying at least the retrieved fraud detection rule to the received transaction data to obtain a result; and
transmitting the result to the requestor via the network interface device.

18. The system of claim 17, wherein the reply to the requestor includes:
a fraud detection approval, subject to other possible transaction approvals, when there is a low or no fraud possibility detected as included in the result from the applying of at least one retrieved fraud detection rule;
an alert when there is a fraud possibility greater than a first threshold detected as included in the result from the applying of at least one retrieved fraud detection rule; and
a transaction denial when there is a fraud possibility greater than a second threshold detected as included in the result from the applying of at least one retrieved fraud detection rule.

19. The system of claim 14, wherein the fraud detection rule is stored in the rule base in a format according to a fraud detection language that limits at least one of data items and operations that may be included in fraud detection rules.
